(19) United States
(12) Patent Application Publication
(10) Pub. No.: US 2018/0147761 A1
(43) Pub. Date: May 31, 2018

(54) COMPOSITE STRUCTURE OF TOUGHENED GLASS AND PLASTIC AND MANUFACTURING METHOD THEREOF

(71) Applicant: Goodlife Technology Co., Ltd, Shenzhen (CN)

(72) Inventor: Funian Chen, Shenzhen (CN)

(21) Appl. No.: 15/466,860

(22) Filed: Mar. 22, 2017

(30) Foreign Application Priority Data
Nov. 30, 2016 (CN) 201611087053.7

(51) Int. Cl. B29C 45/14; B05D 1/02; H04B 1/3888; H04M 1/02

(52) U.S. Cl. CPC B29C 45/14434; B05D 1/02; B29K 2021/003; H04B 1/3888; H04M 1/0202; B29C 45/14311

(57) ABSTRACT

The present invention relates to a composite structure of toughened glass and plastic and a manufacturing method thereof. The composite structure includes a toughened glass layer, and two sides at the edge around the toughened glass layer are coated with a plastic layer. The manufacturing method includes: step 1 of at a junction between a toughened glass layer and a plastic layer, printing or spraying glass paint or gloss paint on a surface of the toughened glass layer as a bridging agent, and spraying or printing a binder bonded with injection-molding rubber on a surface of the bridging agent, the binder being a binder of an IML process; and step 2 of putting the toughened glass layer in an injection mold for injection molding. The present invention achieves high-strength connection between the plastic layer and the toughened glass layer.

### CROSS-REFERENCE TO RELATED APPLICATIONS

The present invention claims the benefit of Chinese Patent Application No. CN201611087053.7, filed on Nov. 30, 2016, which is hereby incorporated by reference as its entirety.

### FIELD OF THE INVENTION

The present invention relates to a composite structure of a product, and in particular, to a composite structure of toughened glass and plastic and a manufacturing method thereof.

### BACKGROUND OF THE INVENTION

In the prior art, in an overmolding injection molding process (also referred to as in mold labeling), from development of the injection mold up to now, all overmolded products are in the following three manners: 1. in secondary injection molding, the product generally includes a body (hard plastic) part and an outer packing (soft plastic) part; 2. the product generally includes a body (hard plastic) part and an outer packing (hard plastic) part, but a first injection (i.e., first injection molding) hard plastic melt temperature should be higher than that of a second injection (i.e., second injection molding), the two procedures, during mold manufacturing, first manufactures a hard plastic body, the main hard plastic mold is designed according to a normal design program, an outer packing (soft plastic) mold is designed by referencing a hard plastic product, shrinkage is not required, the rear mold part is consistent with the hard plastic body, the front mold is different from the rear mold in that it is in an overmolded shape, first produces a hard plastic body during production, and then puts the hard plastic body in an outer packing mold, for outer packing soft plastic injection molding; 3. the plastic is directly coated with hardware. The existing patent documents also have some disclosed technologies, for example, CN201510138379.7 discloses an integral structure of glass and plastic and a manufacturing method thereof. However, further improvement is necessary.

Moreover, it is necessary to further develop and design a structure easy for batch processing and having good performance and a manufacturing method thereof lacking in the current composite structure of glass and plastic.

### SUMMARY OF THE INVENTION

An objective of the present invention is to provide a composite structure of toughened glass and plastic and a manufacturing method thereof, so as to overcome the defects of the prior art.

To achieve the foregoing objective, the present invention adopts the following technical solution:

A composite structure of toughened glass and plastic, including a toughened glass layer, wherein two sides of the edge around the toughened glass layer are coated with a plastic layer.

A further technical solution thereof is: the composite structure is a mobile phone case, including a toughened glass layer for protecting the front or back of a mobile phone, and a plastic frame for protecting sides around the mobile phone, the plastic frame being provided with an inserting recess for inserting the toughened glass layer.

A further technical solution thereof is: a junction plane of the plastic layer and the toughened glass layer is provided with a bonding layer.

A further technical solution thereof is: the bonding layer includes glass paint or gloss paint printed or sprayed on a surface of the toughened glass layer, and a binder located on a surface of the glass paint or gloss paint, the binder being an adhesive of an IML process.

A further technical solution thereof is: two surfaces of the toughened glass layer each are provided with a UV oil film and an explosion-proof film.

A further technical solution thereof is: one surface of the toughened glass layer is provided with a UV oil film and an explosion-proof film, and the other surface of the toughened glass is provided with a transparent plastic layer; an outer surface of the transparent plastic layer is provided with an ink layer.

A manufacturing method of a composite structure of toughened glass and plastic according to the present invention, including:

Step 1 of at a junction between a toughened glass layer and a plastic layer, printing or spraying glass paint or gloss paint on a surface of the toughened glass layer as a bridging agent, and spraying or printing a binder bonded with injection-molding rubber on a surface of the bridging agent, the binder being a binder of an IML process; and

Step 2 of putting the toughened glass layer in an injection mold for injection molding;

Wherein the printing or spraying process completed step by step in step 1 is baked for 1.5-2.5 h in an environment of 75-85 degrees.

A further technical solution thereof is: in step 1, when a binder layer is coated, a secondary procedure is used; firstly, glass paint or gloss paint is printed or sprayed on a contact surface between a glass layer and the plastic as a bridging agent, and secondly, the binder bonded with plastic is printed or sprayed.

A further technical solution thereof is: the plastic layer is a TPU, TPE, PC, PC+ glass fiber, PP, PU or ABS material.

A further technical solution thereof is: before step 1, the toughened glass layer includes a glass body layer and a transparent plastic layer provided with a side surface of the glass body layer, and the glass body layer and the transparent plastic layer are bonded with a 3M glue, and are laminated at a temperature of 60-80 degrees during bonding; an ink layer is coated on an outer surface of the transparent plastic layer by twice or three-times silkscreen; the ink layer, after silkscreen, further includes a processing step of gilding, laser carving, laser and/or anti-counterfeiting, and then baking at a temperature between 75-85 degrees is conducted for 50-70 minutes.

Compared with the prior art, the present invention has the following beneficial effects: The present invention achieves bonding between the toughened glass layer and the plastic layer by using a bonding layer, and achieves binding between the plastic layer and the toughened glass layer through a coated structure, thereby achieving high-strength connection between the plastic layer and the toughened glass layer. The structure may be used in a mobile phone case, to achieve transparent protection over a mobile phone. A surface of the toughened glass layer may be further provided with a mark layer which is provided with a pattern or LOGO, to achieve beautiful design of the product and improve practicality of the product.

The present invention is further described below with reference to the accompanying drawings and specific embodiments.

### BRIEF DESCRIPTION OF THE DRAWINGS

FIG. 1 is a sectional schematic structural diagram of a mobile phone case and a partial enlarged view thereof in a specific embodiment of a composite structure of toughened glass and plastic;

FIG. 2 is a sectional schematic structural diagram of the toughened glass layer in the embodiment of FIG. 1;

FIG. 3 is a more detailed sectional schematic structural diagram of the ink layer and the transparent plastic layer in FIG. 2;

FIG. 4 is a flowchart of a manufacturing method of a composite structure of toughened glass and plastic according to the present invention; and

FIG. 5 is a schematic structural diagram of a box-type pressing machine used in the manufacturing method of a composite structure of toughened glass and plastic according to the present invention.

Description of the reference number in the figures:

| | | | |
|---|---|---|---|
| S | mobile phone case | 90 | toughened glass layer |
| 91 | plastic frame | 92 | inserting recess |
| 94 | bonding layer | 811 | UV oil film |
| 81 | glass body | 82 | transparent plastic layer |
| 812 | explosion-proof film | 831 | color processed ink |
| 83 | ink layer | 833 | impact-resistant ink |
| 832 | high-temperature-resistant ink | 10 | Box |
| T | oven-type pressing machine | 101 | Return channel |
| 100 | Heating channel | 21 | driving wheel |
| 20 | feeding belt | 31 | press-fit base |
| 22 | supporting wheel | 32 | press-fit shelf |
| 311 | moveable bottom plate | | |
| 321 | moveable pressing plate | | |

### DETAILED DESCRIPTION OF ILLUSTRATED EMBODIMENTS

To fully understand the technical contents of the present invention, the technical solution of the present invention is further introduced and described below in combination with specific embodiments, but is not limited thereto.

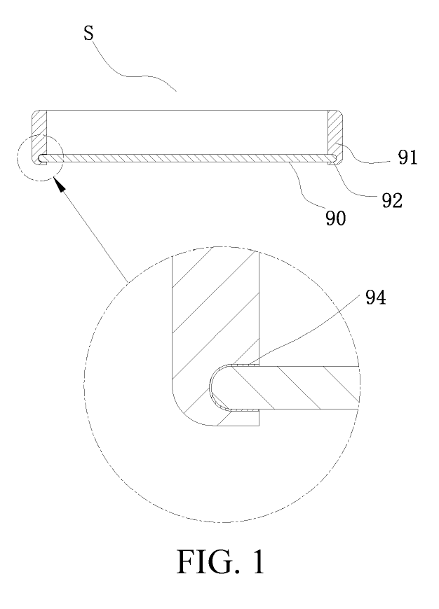

A composite structure of toughened glass and plastic according to the present invention includes a toughened glass layer, two sides of the edge around the toughened glass layer being coated with a plastic layer. In the embodiment as shown in FIG. 1, the composite structure is a mobile phone case S, including a toughened glass layer 90 for protecting the front or back of a mobile phone, and a plastic frame 91 for protecting sides around the mobile phone, the plastic frame 91 being provided with an inserting recess 92 for inserting the toughened glass layer. A junction plane of the plastic layer 91 and the toughened glass layer 90 is provided with a bonding layer 94.

The bonding layer 94 includes glass paint (or referred to as glass gloss paint) printed or sprayed on a surface of the toughened glass layer, and a binder on the surface of the glass paint, and the binder is preferably an adhesive of an IML process.

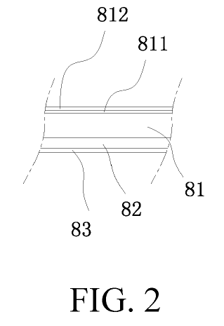

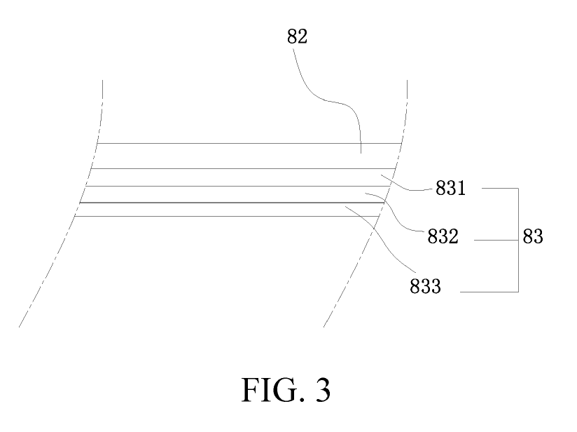

The toughened glass layer may adopt the specific structure as shown in FIG. 2 and FIG. 3, one surface of the glass body 81 is provided with a UV oil film 811 and an explosion-proof film 812, and the other surface of the toughened glass is provided with a transparent plastic layer 82; an outer surface of the transparent plastic layer 82 is provided with an ink layer 83. The ink layer 83 includes color processed ink 831, high-temperature-resistant ink 832, and impact-resistant ink 833 (which may be one of the three kinds of ink in other embodiments).

In other embodiments, any surface or two surfaces of the toughened glass layer may be provided with a UV oil film and an explosion-proof film.

A composite structure of toughened glass and plastic according to the present invention may also be made into another product structure, for example, product labels, various signs, decoration panels or wind-shielding panels used on vehicles, or the like.

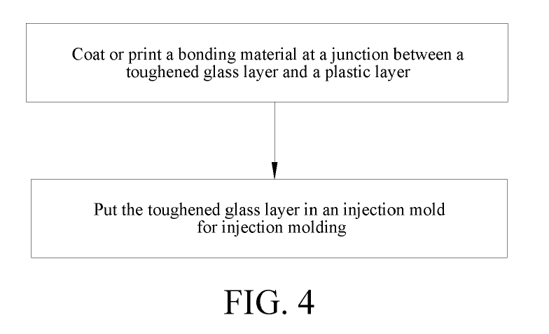

As shown in FIG. 4, the present invention further discloses a manufacturing method of a composite structure of toughened glass and plastic, including:

Step 1 of at a junction between a toughened glass layer and a plastic layer, printing or spraying glass paint or gloss paint on a surface of the toughened glass layer as a bridging agent, and spraying or printing a binder bonded with injection-molding rubber on a surface of the bridging agent, the binder being a binder of an IML process; and

Step 2 of putting the toughened glass layer in an injection mold for injection molding;

Wherein the printing or spraying process completed step by step in step 1 is baked for 1.5-2.5 h in an environment of 75-85 degrees.

In step 1, when a binder layer is coated, a secondary procedure is used; firstly, glass paint or gloss paint is printed or sprayed on a contact surface between a glass layer and the plastic as a bridging agent, and secondly, the binder bonded with plastic is printed or sprayed.

The plastic layer is a TPU, TPE, PC, PC+ glass fiber, PP, PU or ABS material.

In other embodiments, before step 1, the toughened glass layer includes a glass body layer and a transparent plastic layer provided with a side surface of the glass body layer, and the glass body layer and the transparent plastic layer are bonded with a 3M glue, and are laminated at a temperature of 60-80 degrees during bonding; an ink layer is coated on an outer surface of the transparent plastic layer by twice or three-times silkscreen; the ink layer, after silkscreen, further includes a processing step of gilding, laser carving, laser and/or anti-counterfeiting, and then baking at a temperature between 75-85 degrees is conducted for 50-70 minutes. When the toughened glass layer of such a composite structure is used in the mobile phone case, a custom pattern (i.e., a desired pattern formed on the ink layer) may be increased, to improve the decorative function of the mobile phone case.

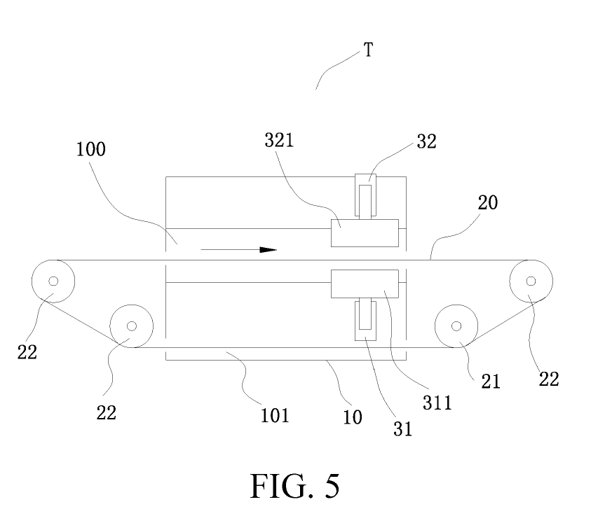

To achieve hot pressing of the glass body layer and the transparent plastic layer, a box-type pressing machine T as shown in FIG. 5 can be used, to achieve rapid large-batch low-cost production. The specific structure is described as follows:

It includes a box 10 which is internally provided with a 60-80-degree heating channel 100 for passing through a workpiece. A continuously rotating feeding belt 20 continuously intermittently moves under the driving of a driving wheel 21, and under the support of a supporting wheel 22, passes through the heating channel 100 and a return channel 101 located below the box 10, to form a feeding cycle. The box 10 is internally provided with a press-fit base 31 and a press-fit shelf 32, a moveable bottom plate 311 is disposed above the press-fit base 31, and a moveable pressing plate 321 is disposed below the press-fit shelf 32. An intermediate region of the feeding belt 20 is provided with several support blocks having smooth surfaces, for placing the transparent plastic layer and the glass layer. During work, the feeding belt 20 stops moving, the moveable bottom plate 311 rises, and the moveable pressing plate 321 falls, to press-fit the transparent plastic layer and the glass layer placed on the support blocks at a constant temperature. After press-fit, the moveable bottom plate and the moveable pressing plate reset, the feeding belt moves, and the press-fit workpiece is removed from the feeding belt by an unloading manipulator or an operator manually. On the other end of the feeding belt, the unloading manipulator or the operator manually puts the transparent plastic layer and the glass layer on the support blocks. The moveable bottom plate and the moveable pressing plate adopt an oil cylinder or air cylinder as a power drive manner.

In summary, the present invention achieves bonding between the toughened glass layer and the plastic layer by using a bonding layer, and achieves binding between the plastic layer and the toughened glass layer through a coated structure, thereby achieving high-strength connection between the plastic layer and the toughened glass layer. The structure may be used in a mobile phone case, to achieve transparent protection over a mobile phone. A surface of the toughened glass layer may be further provided with a mark layer which is provided with a pattern or LOGO, to achieve beautiful design of the product and improve practicality of the product.

The above further describes the technical contents of the present invention only with embodiments, to facilitate readers to understand the technical contents more easily, but it does not represent that implementations of the present invention are only limited thereto. Any technical extension or re-creation based on the present invention are protected by the present invention. The protection scope of the present invention is subject to the claims.

What is claimed is:

1. A composite structure of toughened glass and plastic, comprising a toughened glass layer, wherein two sides of the edge around the toughened glass layer are coated with a plastic layer.

2. The composite structure of toughened glass and plastic according to claim 1, wherein the composite structure is a mobile phone case, comprising a toughened glass layer for protecting the front or back of a mobile phone, and a plastic frame for protecting sides around the mobile phone, the plastic frame being provided with an inserting recess for inserting the toughened glass layer.

3. The composite structure of toughened glass and plastic according to claim 1, wherein a junction plane of the plastic layer and the toughened glass layer is provided with a bonding layer.

4. The composite structure of toughened glass and plastic according to claim 3, wherein the bonding layer comprises glass paint or gloss paint printed or sprayed on a surface of the toughened glass layer, and a binder located on a surface of the glass paint or gloss paint, the binder being an adhesive of an IML process.

5. The composite structure of toughened glass and plastic according to claim 1, wherein two surfaces of the toughened glass layer each are provided with a UV oil film and an explosion-proof film.

6. The composite structure of toughened glass and plastic according to claim 5, wherein one surface of the toughened glass layer is provided with a UV oil film and an explosion-proof film, and the other surface of the toughened glass is provided with a transparent plastic layer; an outer surface of the transparent plastic layer is provided with an ink layer.

7. A manufacturing method of a composite structure of toughened glass and plastic, comprising:
step 1 of at a junction between a toughened glass layer and a plastic layer, printing or spraying glass paint or gloss paint on a surface of the toughened glass layer as a bridging agent, and spraying or printing a binder bonded with injection-molding rubber on a surface of the bridging agent, the binder being a binder of an IML process; and
step 2 of putting the toughened glass layer in an injection mold for injection molding;
wherein the printing or spraying process completed step by step in step 1 is baked for 1.5-2.5 h in an environment of 75-85 degrees.

8. The manufacturing method according to claim 7, wherein in step 1, when a binder layer is coated, a secondary procedure is used; firstly, glass paint or gloss paint is printed or sprayed on a contact surface between a glass layer and the plastic as a bridging agent, and secondly, the binder bonded with plastic is printed or sprayed.

9. The manufacturing method according to claim 7, wherein the plastic layer is a TPU, TPE, PC, PC+ glass fiber, PP, PU or ABS material.

10. The manufacturing method according to claim 7, wherein, before step 1, the toughened glass layer comprises a glass body layer and a transparent plastic layer provided with a side surface of the glass body layer, and the glass body layer and the transparent plastic layer are bonded with a 3M glue, and are laminated at a temperature of 60-80 degrees during bonding; an ink layer is coated on an outer surface of the transparent plastic layer by twice or three-times silkscreen; the ink layer, after silkscreen, further comprises a processing step of gilding, laser carving, laser and/or anti-counterfeiting, and then baking at a temperature between 75-85 degrees is conducted for 50-70 minutes.
